(19) United States
(12) Patent Application Publication
(10) Pub. No.: US 2012/0284031 A1
(43) Pub. Date: Nov. 8, 2012

(54) METHOD AND DEVICE FOR OPERATING TECHNICAL EQUIPMENT, IN PARTICULAR A MOTOR VEHICLE

(75) Inventors: Ronald Hain, Oberasbach (DE); Herbert Meier, Regensburg (DE); Nhu Nguyen Thien, Regensburg (DE); Thomas Rosenstock, Munchen (DE); Alexander Stege, Rohrbach (DE)

(73) Assignee: CONTINENTAL AUTOMOTIVE GMBH, HANNOVER (DE)

(21) Appl. No.: 13/517,961

(22) PCT Filed: Dec. 9, 2010
(86) PCT No.: PCT/EP10/69264

§ 371 Date: Jun. 20, 2012

(30) Foreign Application Priority Data
Dec. 21, 2009 (DE) 10 2009 059 792.1

(51) Int. Cl. G10L 11/00; G06F 3/02; G06F 3/01

(52) U.S. Cl. 704/275; 345/156; 345/168; 704/E11.001

(57) ABSTRACT

A method and device for operating technical equipment, in particular in a motor vehicle. Speech inputs are fed by a speech input unit and manual inputs are fed by means of a manual input unit as operating instructions to a controller by which a command corresponding to the operating instruction is generated and fed to the corresponding technical equipment, which then executes the operating procedure associated with the operating instruction. A basic structure of the command is established by the speech input unit or the manual input unit, and then the basic structure of the command is supplemented by the manual input unit or the speech input unit.

### CROSS REFERENCE TO RELATED APPLICATIONS

This is a U.S. national stage of application No. PCT/EP2010/069264, filed on 9 Dec. 2010. Priority is claimed on German Application No. 10 2009 059 792.1, filed 21 Dec. 2009, the content of which is incorporated here by reference.

### BACKGROUND OF THE INVENTION

1. Field of the Invention

The invention relates to a method and an apparatus for the operator control of technical devices, particularly in a motor vehicle, wherein voice inputs are routed by a voice input unit and manual inputs are routed by a manual input unit as operator control instructions to a control unit that generates a command corresponding to the operator control instruction and routes it to the relevant technical device. The relevant technical device then executes the operator control operation associated with the operator control instruction.

2. Description of Prior Art

In the case of an apparatus of the type cited at the outset, it is a known practice for operator control instructions to be input either purely by navigation and operation of a touchscreen menu or purely by pushing a push-to-talk key and subsequently making a voice input.

With the increasing complexity and diversity of the electrical and electronic systems in motor vehicles, operator control of all the functions is becoming barely comprehensible.

If only the keys on the touchscreen are used, the number of keys is becoming barely comprehensible.

Pure voice control quickly reaches its limits when complex mechanisms are being controlled, since it is either necessary to make a natural-language dialog possible, which entails great resource requirements, or the user is forced to learn a list of commands by heart.

### SUMMARY OF THE INVENTION

It is an object of the invention to provide a method and an apparatus for the operator control of technical devices, with simple operator control being made possible even when the technical devices have a relatively high level of complexity.

This object is achieved by the voice input unit or the manual input unit stipulating a basic structure for the command and then the manual input unit or the voice input unit adding to the basic structure of the command.

The method involves the input unit activated first making a preselection and then involves the input unit activated next making a subselection.

Only a limited number of operator control instructions are required for the voice input unit and the manual input unit.

The operator control operation may be actuation for the purpose of operating an appliance. In addition, an operator control operation may be actuation of one or more components of an infotainment system, which may contain a telephone book or navigation information, for example.

It goes without saying that there may also be further input stages.

If the voice input is stored continuously in a ring buffer in the voice input unit, the ring buffer provides a period of time in the voice input for voice recognition prior to the starting time of the voice recognition. The last few seconds or minutes of the recorded voice input are always available for the voice recognition.

Voice recognition by the voice input unit can be activated by manual operation of a switching element and/or by a gesture recognition element.

In this case, the switching element may be a separate switching element or an element of the manual input unit.

Voice recognition that continuously runs concomitantly in the background is avoided, which would be very costly in terms of resources and would easily result in recognition errors.

The operator control instructions from the voice input unit preferably comprise code words stored in the control unit, which are stored as a Thesaurus.

The method and the apparatus can preferably be used for technical devices in a motor vehicle. The invention is not limited to such an application, however, but rather can also be applied to other areas of application, such as automatic ticket machines.

The object is achieved for an apparatus by a voice input unit and a manual input unit for triggering operator control instructions which can be routed to a control unit and which can generate a command corresponding to the operator control instruction. The command can be routed to the relevant technical device, which can then execute the operator control operation associated with the operator control instruction. The voice input unit or the manual input unit brings about a basic structure for the command and then the manual input unit or the voice input unit adds to the basic structure of the command.

The manual input unit may have a keypad, wherein the input unit preferably has a touch-sensitive keypad, particularly a touchscreen.

If the apparatus has a display having a display panel for displaying image representations and/or basic structures for the commands and/or additions to the basic structures of the commands, which basic structures and/or additions can be stipulated by the manual input unit or the voice input unit, and/or for displaying menus and/or submenus, then the combination with the manual input allows the memory input to be presented in the context of an object shown on the display panel, without the need to increase the vocabulary of the voice recognition unit. If the voice input makes reference to a certain object, said object can be referenced by “here”, “there” or “this”, for example, instead of having to name it. By dividing the keypad into different domains such as “switches”, “signal lamps” and “road map” for the voice recognition unit, a significant increase in the recognition rate is achieved.

Conversely, extending the push of a key with a voice input results in a type of spoken context menu. If a method based on the prior art has several possible actions in response to the push of a pushbutton, a list (context menu) is shown on the display panel, from which the user must retrieve and select the desired option. In the case of the method according to one embodiment of the invention, this selection is made automatically by virtue of the evaluation of the voice input.

Preferably, the display is an electro-optical display, such as an LCD.

In order to combine the manual input unit with presentations on the display panel of the display, the display panel may be lodged behind the transparent manual input unit.

This can result in very intuitive operator control steps, such as tapping on a particular point on a displayed map or road map in conjunction with the voice input “take me there” or “how far is it to there?”.

The semantic information which the voice input contains can even relate a series of manual inputs to one another, for example as a result of striking two different points on the map in conjunction with the question “How far is it from there to there?”.

### BRIEF DESCRIPTION OF THE DRAWINGS

Exemplary embodiments of the invention are presented in the drawing and are described in more detail below. In the drawing:

FIG. 1 is a block diagram of an apparatus for the operator control of technical devices in a motor vehicle;

FIG. 2 is a flowchart for a method for ascertaining and actuating a function; and

FIG. 3 is a flowchart for a method for ascertaining and actuating an object.

### DETAILED DESCRIPTION OF THE PREFERRED EMBODIMENTS

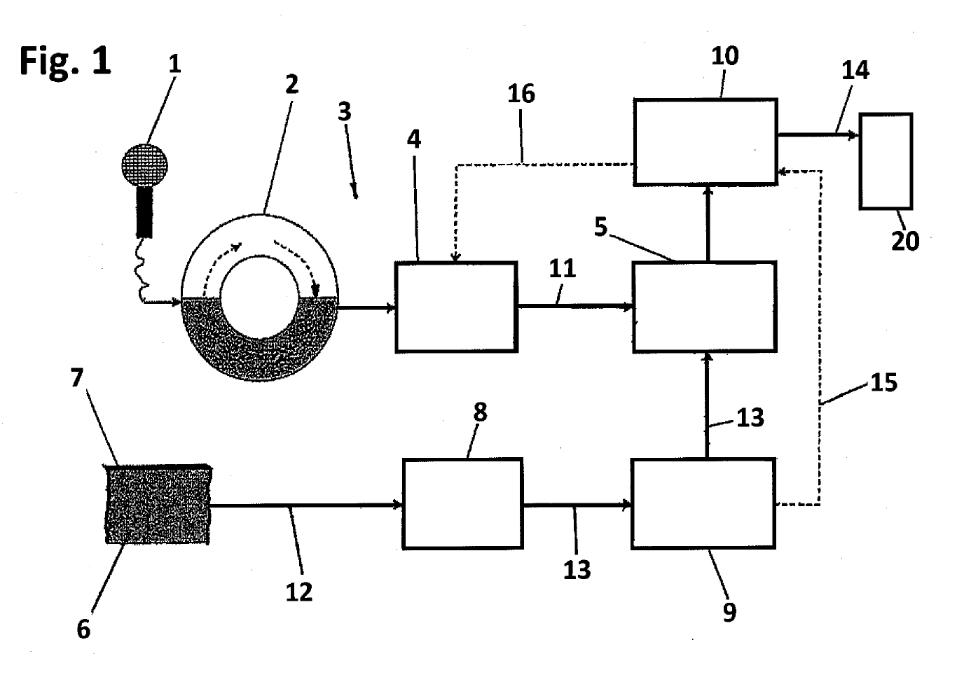

The apparatus shown in FIG. 1 has a microphone 1 for voice input into a ring buffer 2 in a voice input unit 3.

The voice input unit 3 also has a voice recognition unit 4 which compares the voice input with code words from a stored thesaurus of code words, and, in the event of a voice input being recognized and associated with one or more stored code words, an appropriate voice signal 11 is generated and is routed to a combining unit 5.

In addition, there is an LCD screen 6 having a transparent touchscreen 7 arranged in front of it, wherein the touchscreen 7 is divided into a plurality of touch positions.

The contact signal 12 generated by manually hitting a touch position is recorded in a touchscreen unit 8, and an appropriate touch signal 13 is likewise routed to the combining unit 5 via a graphical user interface 9 which controls the display on the LCD screen 6.

The touch signal 13 and the voice signal 11 are supplied from the combining unit 5 to a control unit 10, which generates an appropriate command 14 and routes it to a technical device 20 for execution.

If it has not yet been activated, the voice input unit 3 needs to be activated beforehand. To this end, an appropriate starting touch position on the touchscreen 7 is hit, as a result of which the graphical user interface is used to route a starting signal 15 to the control unit 10, which then routes an activation signal 16 to the voice recognition unit 4 and hence activates the voice input unit 3.

In the flowchart shown in FIG. 2, the desired function is first of all ascertained on a touchscreen by operating the relevant touchscreen co-ordinate.

If it is also found that a voice input unit has been activated, a recognition unit vocabulary from a code word thesaurus is set for the selected function.

A name that has been captured by a voice input unit is checked to determine whether it is valid or not valid.

If the voice input is not valid, a new voice input needs to occur.

If the voice input is valid, the name (code word) is linked to the function selected on the touchscreen, and an appropriate execution command is output.

If the voice input has not been activated, the name (code word) can also be input using a graphical user interface on the touchscreen and can thus trigger the execution command.

In the flowchart shown in FIG. 3, the desired object is first of all ascertained on a touchscreen by operating the relevant touchscreen co-ordinate.

If it is also found that a voice input unit has been activated, a recognition unit vocabulary for possible commands from a command thesaurus is set for the selected object.

A spoken command captured by a voice input unit is checked to determine whether it is valid or invalid.

If the voice command is not valid, a new voice input needs to take place.

If the voice command is valid, the command is linked to the object selected on the touchscreen, and an appropriate execution command is output.

A number of flow examples are presented below.

Voice command following selection of a display object

Selection of an Object by Voice:
The user has the map presentation on his infotainment system open and it is possible to see the special destination symbols on the map;
The user strikes the touchscreen at the position of a hotel symbol and says “Info”;
The system recognizes the selection of the special destination;
The system recognizes from the voice activity that the user has a particular request. In the absence of voice activity, nothing happens;
The system loads the command vocabulary for the relevant processing and for the voice recognition with the audio data;
The system recognizes the “Info” command; and
The system shows a pop-up window with the information about this hotel, e.g. name, address and telephone number.

Selection of a Function by Voice:
The pop-up window has two keys, for example, “call” and “navigate”;
The user strikes the window at a position outside the two keys and says “Call”;
The system loads the command vocabulary for the relevant processing and for the voice recognition with the audio data;
The system dials the telephone number of the hotel.

Voice command is given before a key on the touchscreen is pushed.

Selection of a Function by Voice:
The user has the telephone book on his infotainment system open and wishes to delete an entry;
The user says “delete entry”;
The user strikes the touchscreen at the list position for the entry that is to be deleted;
The system recognizes the selection of the list entry;
The system recognizes from the voice activity that the user has a particular request. If there is no voice activity, the standard function “dial”, for example, would be executed;
The system loads the command vocabulary for the processing of a list entry and performs the voice recognition with the stored audio data;
The system recognizes the “delete entry” command; and
The system deletes the selected list entry.

Selection of an Object by Voice:
The user has the media player on his infotainment system open and wishes to select a particular CD or playlist for playback;
The user says “Beatles, White Album”;
The user strikes the touchscreen for the “play” function selection; and
The system recognizes the desired “play” function;
The system recognizes from the voice activity that “play” is intended to be linked to a secondary condition;
The system loads the vocabulary for all playable media and performs the voice recognition with the stored audio data;
The system recognizes the title selection “Beatles, White Album”; and
The system plays the selected CD.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A method for operator control of devices in a motor vehicle, comprising:
routing at least one of a voice input by a voice input unit and a manual input by a manual input unit to a control unit as an operator control instruction;
generating a command by the control unit corresponding to the operator control instruction;
routing the command to a respective device, which then executes an operator control operation associated with the operator control instruction;
stipulating by the at least one of the voice input unit and the manual input unit a basic structure for the command; and
adding by the at least one of the voice input unit and the manual input unit the basic structure to the command.

12. The method as claimed in claim 11, further comprising:
storing the voice input continuously in a ring buffer in the voice input unit,
wherein the ring buffer provides a period of time in the voice input for voice recognition prior to a starting time of the voice recognition.

13. The method as claimed in claim 12, further comprising:
activating the voice recognition by the voice input unit by at least one of manual operation of a switching element and a gesture recognition element.

14. The method as claimed in claim 11, wherein the operator control instruction from the voice input unit comprises a code word stored in the control unit.

15. An apparatus for operator control of technical devices in a motor vehicle, comprising:
a voice input unit configured to trigger operator control instructions;
a manual input unit configured to triggering the operator control instructions;
a control unit that receives the operator control instructions and generates a command corresponding to the operator control instruction that is routed to a respective technical device that executes an operator control operation associated with the command,
wherein at least one of the voice input unit and the manual input unit establishes a basic structure for the command and then at least one of the voice input unit and the manual input unit enables the basic structure of the command.

16. The apparatus as claimed in claim 15, wherein the manual input unit is a keypad.

17. The apparatus as claimed in one of claim 15, wherein the manual input unit has a touch-sensitive keypad.

18. The apparatus as claimed in claim 15, further comprising:
a display having a display panel for displaying at least one of image representations, basic structures for the commands and additions to the basic structure of the commands,
wherein at least one of the basic structures and the additions are stipulated by one of the manual input unit and the voice input unit, for displaying at least one of menus and submenus.

19. The apparatus as claimed in claim 18, wherein the display is an electro-optical display.

20. The apparatus as claimed in one of claim 18, wherein the display panel is arranged behind the transparent manual input unit.

21. The apparatus as claimed in one of claim 16, wherein the keypad is a touch-sensitive keypad.

22. The apparatus as claimed in claim 17, further comprising:
a display having a display panel for displaying at least one of image representations, basic structures for the commands and additions to the basic structures of the commands,
wherein at least one of the basic structures and the additions are stipulated by one of the manual input unit and the voice input unit, for displaying at least one of menus and submenus.
